(19) United States
(12) Patent Application Publication
(10) Pub. No.: US 2015/0277020 A1
(43) Pub. Date: Oct. 1, 2015

(54) LED LIGHT-MIXING DEVICE AND A LIGHTING AND/OR SIGNAL INDICATION DEVICE

(71) Applicant: Valeo Lighting Hubei Technical Center Co, Ltd, Wuhan (CN)

(72) Inventor: Chen CHEN, Hubei (CN)

(21) Appl. No.: 14/674,137

(22) Filed: Mar. 31, 2015

(30) Foreign Application Priority Data
Apr. 1, 2014 (CN) 201420155305.5

(51) Int. Cl. F21V 8/00

(52) U.S. Cl. CPC G02B 6/0021; G02B 6/0068; G02B 6/0026; G02B 6/0091

(57) ABSTRACT

A light-emitting diode (LED) light-mixing device, comprising a first LED, used to emit light of a first color; a second LED, used to emit light of a second color that is different from the first color; and a light-mixing light guide; the light-mixing light guide is provided with a first inlet, a second inlet, and an outlet; the first inlet is used to receive the light of the first color emitted by the first LED; the second inlet is used to receive the light of the second color emitted by the second LED; and mixed light is emitted from the outlet. The present utility model also discloses a lighting and/or signal indication device. The present utility model, by performing light mixing in a light-mixing light guide, can obtain light of various colors to complete lighting and/or signal indication functions.

### CROSS-REFERENCE TO RELATED APPLICATIONS

This application claims priority to Chinese Utility Model No. 201420155305.5 filed on Apr. 1, 2014, which application is incorporated herein by reference and made a part hereof.

### BACKGROUND OF THE INVENTION

1. Field of the Invention

The present utility model relates to the technical field of lighting and signal indication, particularly to an LED light-mixing device and a lighting and/or signal indication device provided with the LED light-mixing device.

2. Description of the Related Art

Light-emitting diodes (LEDs), with small sizes and high luminous efficiencies, have become the mainstream light source components. For example, LEDs can be used for a wide variety of luminaires, such as indicator lights and road illuminating lamps. However, when homogenous LEDs are used as light sources, due to their limited wavelength ranges, the types of the colors of the emitted light are limited. In certain cases, the application needs cannot be met. Thus, LEDs with narrow luminescent spectra are needed to generate illuminating light with wide wavelength ranges.

### SUMMARY OF THE INVENTION

The purpose of the present utility model is to provide a device that can complete effective light mixing on LEDs and a lighting and/or signal indication device having the light mixing function.

In order to achieve the aforesaid purpose, the technical solution of the present utility model is implemented as follows:

According to an aspect of the present utility model, an LED light-mixing device is provided, comprising:

a first LED, used to emit light of a first color;

a first LED, used to emit light of a first color;

a second LED, used to emit light of a second color that is different from the first color; and

a light-mixing light guide; the light-mixing light guide is provided with a first inlet, a second inlet, and an outlet; the first inlet is used to receive the light of the first color emitted by the first LED; the second inlet is used to receive the light of the second color emitted by the second LED; and mixed light is emitted from the outlet.

Further, the first inlet and the second inlet are located on the same side of the light-mixing light guide.

Further, the first inlet and the second inlet are respectively located on one of the two opposite sides or one of the two adjacent sides of the light-mixing light guide.

Further, the light-mixing light guide is provided with a first branch portion and a second branch portion; the first inlet is located in the end part of the first branch portion; and the second inlet is located in the end part of the second branch portion.

Further, the light-mixing light guide is provided with a phosphorus layer at the first inlet and/or the second inlet.

Specifically, the light-mixing light guide is provided with a scattering bulge at the first inlet and/or the second inlet and/or the outlet.

Specifically, the LED light-mixing device comprises a plurality of the first LEDs and a plurality of the second LEDs; the first LEDs and/or the second LEDs can be connected or disconnected in all or in part.

Specifically, the LED light-mixing device further comprises a third LED, used to emit light of a third color different from the first color and the second color; the light-mixing light guide is further provided with a third inlet; the third inlet is used to receive the light of a third color emitted by the third LED.

Specifically, the LED light-mixing device further comprises a color mixture adjustment device connected to the first LED and/or the second LED; the color mixture adjustment device can adjust the optical power of the first LED and/or the second LED or control the connection and disconnection of the first LED and/or the second LED to adjust the color of the light emitted from the outlet of the light-mixing light guide.

According another aspect of the present utility model, a lighting and/or signal indication device is further provided, comprising an LED light-mixing device disclosed in the aforesaid technical solution.

In at least one aspect of the aforesaid technical solution of the present utility model, by means of light-mixing in a light-mixing light guide, illuminating light of varying colors can be obtained to complete various lighting and/or signal indication functions and even achieve decorative effects.

These and other objects and advantages of the invention will be apparent from the following description, the accompanying drawings and the appended claims.

### BRIEF DESCRIPTION OF THE ACCOMPANYING DRAWINGS

FIG. 1 shows a schematic diagram for an LED light-mixing device of an embodiment of the present utility model;

FIG. 2 shows a schematic diagram for an LED light-mixing device of another embodiment of the present utility model; and

FIG. 3 shows a schematic diagram for an LED light-mixing device of yet another embodiment of the present utility model.

### DETAILED DESCRIPTION OF THE PREFERRED EMBODIMENTS

By referring to specific embodiments and the drawings, the following describes in detail the technical solution of the present utility model. In the specification, the same or similar reference number is used for the same or similar component. The following description of specific embodiments of the present utility model by referring to the drawings is intended to explain the overall conception of the present utility model, instead of being understood as a limitation of the present utility model.

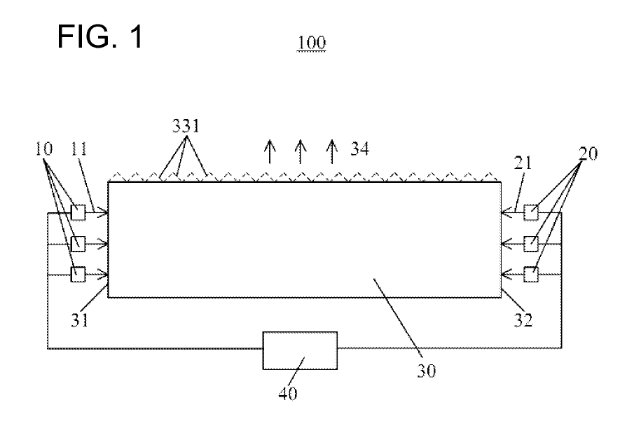

FIG. 1 shows an embodiment of a LED light-mixing device 100 according to the present utility model. The LED light-mixing device 100 comprises a first LED 10, a second LED 20, and a light-mixing light guide 30. The first LED 10 is used to emit light of a first color 11; the second LED 20 is used to emit light of a second color 21 that is different from the first color 11. The light-mixing light guide 30 is provided with a first inlet 31, a second inlet 32, and an outlet 33 (FIG. 3). The first inlet 31 is used to receive the light of the first color 11 emitted by the first LED 10; the second inlet 32 is used to receive the light of the second color 21 emitted by the second LED 20; and mixed light 34 is emitted from the outlet 33.

Though FIG. 1 shows three first LEDs 10 and three second LEDs 20, the number of the first LEDs 10 and that of the second LEDs 20 are not limited to those values. For example, one, two, three, four, five, or more first LEDs 10 and/or second LEDs 20 can be used. In addition, the number of the first LEDs 10 and that of the second LEDs 20 are not necessarily the same. For example, the first LEDs 10 and the second LEDs 20 can be arranged in a one-dimensional array or a two-dimensional array.

In the aforesaid embodiment, the mixed light 34 is generated by mixing the light of the first color 11 with the light of the second color 21. For example, if the first color 11 is red and the second color 21 yellow, the mixed light 34 can be amber (yellowish-brown); if the first color 11 is amber and the second color 21 blue, the mixed light 34 can be white. Though FIG. 1 shows LEDs of only two colors, it should be understood that LEDs of three colors can also be used for light mixing. For example, if the first color 11 is red; the second color 21 is yellow; and the third color (not shown) is blue, the mixed light 34 is white. In the example where LEDs of three colors are used for light mixing, the LED light-mixing device 100 can further comprise a third LED (not shown) that is used to emit light of a third color different from the first color and the second color. Accordingly, the light-mixing light guide 30 can further be provided with a third inlet (not shown); the third inlet is used to receive the light of a third color emitted by the third LED. Certainly, LEDs of more colors can be used for light mixing to obtain more types of light.

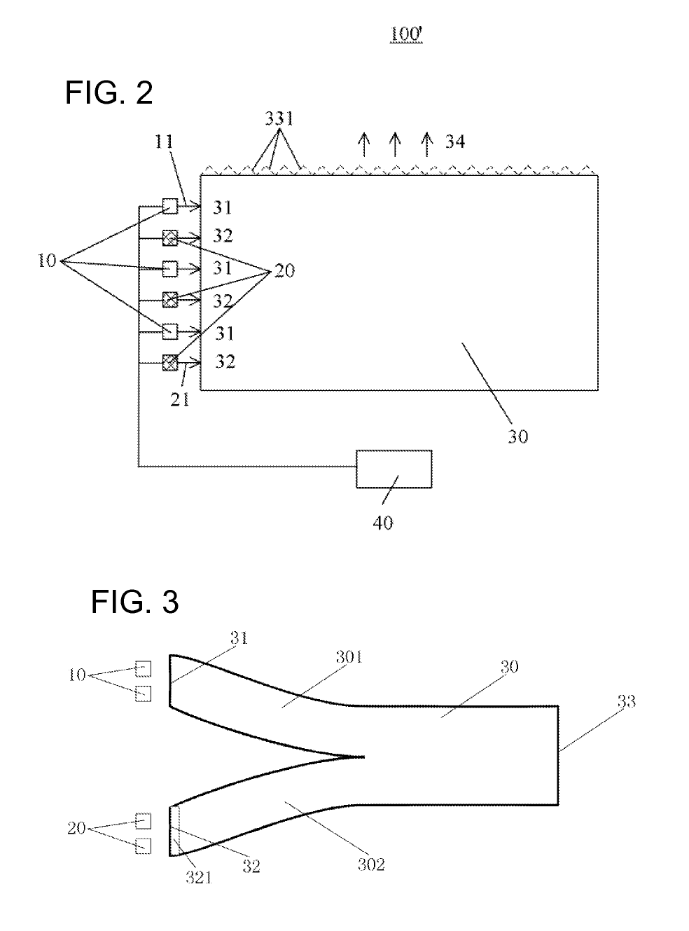

In the embodiment shown in FIG. 1, the first LED 10 and the second LED 20 are respectively located on one of the two opposite sides of the light-mixing light guide 30. Accordingly, the first inlet 31 and the second inlet 32 of the light-mixing light guide 30 are respectively located on one of the two opposite sides of the light-mixing light guide 30. However, the arrangement of the first LEDs 10 and that of the second LEDs 20 is not limited to the aforesaid arrangement. The first LEDs 10 and the second LEDs 20 can be arranged on the same side of the light-mixing light guide 30, for example, in the LED light-mixing device 100′ shown in FIG. 2. In the LED light-mixing device 100′ shown in FIG. 2, the first LEDs 10 and the second LEDs 20 are alternately arranged on the same side (the left side shown in FIG. 2) of the light-mixing light guide 30. The first inlets 31 and the second inlets 32 of the light-mixing light guide 30 corresponding to the first LEDs 10 and the second LEDs 20 are also alternately arranged on the surface on the side of the light-mixing light guide 30. For example, if a plurality of first LEDs 10 and a plurality of second LEDs 20 are used, the first LEDs 10 and the second LEDs 20 can be arranged in parallel or alternately. In addition, in another example, the first LED 10 and the second LED 20 can also be respectively located on one of the two adjacent sides of the light-mixing light guide 30. Similarly, if a third LED is used (not shown), the third LED can also be located on the same side or a different side of the light-mixing light guide 30 as the first LED 10 and/or second LED 20.

FIG. 3 shows a specific structure of an LED light-mixing device according to the present utility model. As shown in the figure, the light-mixing light guide 30 is provided with the first branch portion 301 and the second branch portion 302; the first inlet 31 is located in the end part of the first branch portion 301; and the second inlet 32 is located in the end part of the second branch portion 302. The first LED 10 is arranged opposite to the first inlet 31; the second LED 20 is arranged opposite to the second inlet 32. The outlet 33, through which mixed light 34 is emitted, for example, can be configured on the right of the light-mixing light guide 30 shown in FIG. 3. However, such configuration is not required. Alternatively, the outlet 33 can be configured on another side of the light-mixing light guide 30. Optionally, the light-mixing light guide 30 can be provided with the phosphorus layer 321. The phosphorus layer 321 can, after receiving the light, for example, blue light, emitted by an LED, transmit phosphorescence that enters the light-mixing light guide 30 to achieve optical effects different from those achieved by directly transmitting the light emitted by an LED into the light-mixing light guide 30. As shown in FIG. 3, the phosphorus layer 321 is configured only at the second inlet 32. However, the present utility model is not limited to this configuration. For example, the phosphorus layer 321 can also be configured at the first inlet 31 or at both the first inlet 31 and the second inlet 32.

The light-mixing light guide 30 can be provided with a scattering bulge 331 at the first inlet 31 and/or the second inlet 32 and/or outlet 33 (as indicated by the broken lines shown on the light-mixing light guide 30 in FIG. 1 and FIG. 2) to enhance the light mixing effects of the light-mixing light guide 30.

For example, the LED light-mixing device 100 can further comprise a color mixture adjustment device 40 (FIGS. 1 and 2) connected to the first LED 10 and/or the second LED 20; the color mixture adjustment device 40 can adjust the optical power of the first LED 10 and/or the second LED 20 or control the connection and disconnection of the first LED 10 and/or the second LED 20 to adjust the color of the light emitted from the outlet 33 of the light-mixing light guide 30. In the actual application, the color mixture adjustment device 40 can be used to achieve various illumination effects or modes. For example, if the color mixture adjustment device 40 sets the first LED 10 to low optical power and the second LED 20 to high optical power, the mixed light 34 can be used for the direction signal lamps of automobiles; if the color mixture adjustment device 40 sets the first LED 10 to high optical power and the second LED 20 to low optical power, the mixed light 34 can be used for brake lamps; if the color mixture adjustment device 40 sets both the first LED 10 and the second LED 20 to high optical power, the mixed light 34 can be used for illuminating lamps. The preceding description is only exemplary.

If a plurality of first LEDs 10 and a plurality of second LEDs 20 are used, the first LEDs 10 and/or the second LEDs 20 can be connected or disconnected in all or in part. By connecting or disconnecting all or some of the first LEDs 10 and/or the second LEDs 20, mixed light 34 of varying intensity and colors can be obtained to complete different functions.

The present utility model further provides a lighting and/or signal indication device that comprises any of the LED light-mixing devices described in the aforesaid examples.

Lighting and/or signal indication devices according to the present utility model can be used as the lighting and/or signal indication lamps of motorized vehicles or the lamps of non-motorized vehicles, and can also be used in other lighting and/or signal indication fields, such as flashlights and signal lamps.

The specification describes the present utility model by referring to the drawings. However, the embodiments disclosed in the drawings are intended to demonstrate preferred modes of implementing the present utility mode, instead of limiting the scope of the present utility model.

While the present utility model has been particularly described above with reference to preferred embodiments, those of ordinary skill in the art can understand that any alterations made to the above-mentioned embodiments without departing from the spirit or principle of the present utility model shall fall within the scope as defined by the Claims or by their equivalents.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. An LED light-mixing device, wherein said LED light-mixing device comprises:
a first LED, used to emit light of a first color;
a second LED, used to emit light of a second color that is different from said first color; and
a light-mixing light guide; said light-mixing light guide is provided with a first inlet, a second inlet, and an outlet; said first inlet is used to receive the light of said first color emitted by said first LED; said second inlet is used to receive the light of said second color emitted by said second LED; and mixed light is emitted from said outlet.

2. The LED light-mixing device according to claim 1, wherein said first inlet and said second inlet are located on the same side of said light-mixing light guide.

3. The LED light-mixing device according to claim 1, wherein said first inlet and said second inlet are respectively located on one of the two opposite sides or one of the two adjacent sides of said light-mixing light guide.

4. The LED light-mixing device according to claim 1, wherein said light-mixing light guide is provided with a first branch portion and a second branch portion; said first inlet is located in an end part of said first branch portion; and said second inlet is located in an end part of said second branch portion.

5. The LED light-mixing device according to claim 4, wherein said light-mixing light guide is provided with a phosphorus layer at said first inlet and/or said second inlet.

6. The LED light-mixing device according to claim 1, wherein said light-mixing light guide is provided with a scattering bulge at said first inlet and/or said second inlet and/or said outlet.

7. The LED light-mixing device according to claim 1, wherein said LED light-mixing device comprises a plurality of said first LEDs and a plurality of said second LEDs; said first LEDs and/or second LEDs can be connected or disconnected in all or in part.

8. The LED light-mixing device according to claim 1, wherein said LED light-mixing device further comprises a third LED, used to emit light of a third color different from said first color and said second color; said light-mixing light guide is further provided with a third inlet; said third inlet is used to receive the light of said third color emitted by said third LED.

9. The LED light-mixing device according to claim 1, wherein said LED light-mixing device further comprises a color mixture adjustment device connected to said first LED and/or said second LED; said color mixture adjustment device can adjust an optical power of said first LED and/or said second LED or control the connection and disconnection of said first LED and/or said second LED to adjust the color of the light emitted from said outlet of said light-mixing light guide.

10. A lighting and/or signal indication device, wherein said lighting and/or signal indication device comprises an LED light-mixing device disclosed in claim 1.

11. The LED light-mixing device according to claim 2, wherein said light-mixing light guide is provided with a scattering bulge at said first inlet and/or said second inlet and/or said outlet.

12. The LED light-mixing device according to claim 2, wherein said LED light-mixing device comprises a plurality of said first LEDs and a plurality of said second LEDs; said first LEDs and/or second LEDs can be connected or disconnected in all or in part.

13. The LED light-mixing device according to claim 2, wherein said LED light-mixing device further comprises a third LED, used to emit light of a third color different from said first color and said second color; said light-mixing light guide is further provided with a third inlet; said third inlet is used to receive the light of said third color emitted by said third LED.

14. The LED light-mixing device according to claim 2, wherein said LED light-mixing device further comprises a color mixture adjustment device connected to said first LED and/or said second LED; said color mixture adjustment device can adjust an optical power of said first LED and/or said second LED or control the connection and disconnection of said first LED and/or said second LED to adjust the color of the light emitted from said outlet of said light-mixing light guide.

15. A lighting and/or signal indication device, wherein said lighting and/or signal indication device comprises an LED light-mixing device disclosed in claim 2.

16. The LED light-mixing device according to claim 3, wherein said light-mixing light guide is provided with a scattering bulge at said first inlet and/or said second inlet and/or said outlet.

17. The LED light-mixing device according to claim 3, wherein said LED light-mixing device comprises a plurality of said first LEDs and a plurality of said second LEDs; said first LEDs and/or second LEDs can be connected or disconnected in all or in part.

18. The LED light-mixing device according to claim 3, wherein said LED light-mixing device further comprises a third LED, used to emit light of a third color different from said first color and said second color; said light-mixing light guide is further provided with a third inlet; said third inlet is used to receive the light of said third color emitted by said third LED.

19. The LED light-mixing device according to claim 3, wherein said LED light-mixing device further comprises a color mixture adjustment device connected to said first LED and/or said second LED; said color mixture adjustment device can adjust an optical power of said first LED and/or said second LED or control the connection and disconnection of said first LED and/or said second LED to adjust the color of the light emitted from said outlet of said light-mixing light guide.

20. A lighting and/or signal indication device, wherein said lighting and/or signal indication device comprises an LED light-mixing device disclosed in claim 3.
